(19) United States
(12) Patent Application Publication
(10) Pub. No.: US 2026/0349392 A1
(43) Pub. Date: Nov. 5, 2026

(54) MUSICAL OR STRIKING WATCH

(71) Applicant: Montres Breguet S.A., L'Abbaye (CH)

(72) Inventors: Younes KADMIRI, Montfaucon (FR); Grégory GAUTHIER, Saint-Cergue (CH); Jérôme MACE, Le Pont (CH)

(73) Assignee: Montres Breguet S.A., L'Abbaye (CH)

(21) Appl. No.: 19/371,249

(22) Filed: Oct. 28, 2025

(30) Foreign Application Priority Data
Dec. 5, 2024 (EP) 24217791.3

(51) Int. Cl. G04B 37/00; G04B 19/28

(52) U.S. Cl. CPC G04B 37/0008; G04B 19/283

(57) ABSTRACT

A musical or striking watch (100) including a watchcase including a bezel (1), a middle (2), a back (3), a dial (4) and a glass (5), the glass (5) being attached to the bezel (1), the glass (5) and the dial (4) forming an inner chamber (8) with an initial volume (V), a movement (6) and a striking mechanism (7). The bezel (1) is telescopic and moves between a closed position in which the glass (5) is in a first plane (P1) parallel to the dial plane (Pc), to a second position in which the glass (5) is in a second plane (P2) distant from the first plane (P1) and parallel to the dial plane (Pc) so as to increase the initial volume (V) of the inner chamber (8).

### CROSS-REFERENCE TO RELATED APPLICATIONS

This application claims priority to European Patent Application No. 24217791.3, filed on Dec. 5, 2024, the entire contents of which are incorporated herein by reference.

### TECHNICAL FIELD OF THE INVENTION

The invention relates to the field of mechanical horology. More specifically, it relates to a musical or striking watch fitted with a special arrangement for acoustic radiation.

### Technological background

A watch can be fitted with a striking mechanism to generate a sound or music. To do this, the gong on the striking watch or the keyboard on the musical watch is usually arranged inside the watchcase. The vibrations from the gong or from the keys on the keyboard are thus transmitted to the various external parts. These external parts include, for example, the middle, bezel, glass and back of the watchcase. These large external parts begin to radiate sound into the air under the effect of the transmitted vibrations. When a sound is produced either by one or more gongs struck by a hammer or by one or more vibrating keys on the keyboard, these external parts can radiate the sound produced into the air.

A membrane can be fitted in the watchcase and configured to improve the acoustic level of the sound or of the music generated. Other external parts on the watch can also be designed to enhance sound radiation, particularly at low frequencies. However, it is difficult to optimise acoustic radiation from the back of the watchcase, which is often an almost acoustically inactive external part of the watch.

Another drawback is that when the watch is worn on a user's wrist, the vibration of the lower surface of the watchcase back is dampened by contact with the wrist. In this case, one solution for creating a sound or music coming from the back of the watchcase is to use side openings. Nevertheless, the radiation coming out of the side openings in the back is still low because several parts surrounding said openings are rigid. Moreover, if the back is fitted with a glass to allow the movement to be viewed from the underside, grime can enter through the openings in the back and settle inside the watch.

### SUMMARY OF THE INVENTION

The invention aims to remedy the drawbacks of the aforementioned prior art by providing a musical or striking watch fitted with a telescopic bezel that enables the acoustic level on the dial side of the watch to be improved.

To this end, the present invention relates to a musical or striking watch comprising a watchcase consisting of at least a middle, a back, a dial, a bezel and a glass, the glass being attached to the bezel, the glass and the dial forming an inner chamber with an initial volume, a movement and a striking mechanism, characterised in that the bezel is telescopic and moves between a closed position in which the glass is in a first plane parallel to the dial plane, to a second position in which the glass is in a second plane distant from the first plane and parallel to the dial plane so as to increase the initial volume of the inner chamber.

According to other advantageous variants of the invention:
the bezel comprises an upper portion designed to hold the glass and a lower portion connecting with the middle, the lower portion and upper portion being delimited by a flange onto which the glass is fastened;
the bezel comprises at least one through orifice through which the inner chamber communicates with the outside of the watchcase so that the strike or music can be heard;
the at least one orifice is on the lower portion of the bezel;
the lower portion of the bezel comprises at least one guide groove for moving the bezel from the closed position to the deployed position and inversely;
the middle comprises an annular groove for holding the lower portion of the bezel and closing off the at least one orifice when the bezel is in the closed position;
the annular groove comprises protruding pins arranged to engage with the at least one guide groove;
the middle comprises a gasket suitable for engaging with the bezel when the bezel is in the closed position;
the at least one through orifice has a micro-perforated film to keep out dust or dirt;
the micro-perforated film is made of paper, textile, metal or a composite material;
the dial forms an acoustic membrane;
the telescopic bezel is fitted to the back of the watch.

### BRIEF DESCRIPTION OF THE FIGURES

Other features and advantages of the invention will become apparent from the following detailed description, given by way of non-limiting example, with reference to the attached drawings in which:

FIG. 1 is an exploded perspective view of a watch according to the invention;

FIG. 2a is a perspective view of a bezel on a watch according to the invention;

FIG. 2b illustrates a cross-sectional view of the bezel in FIG. 2a.

FIGS. 3a and 3b illustrate cross-sectional views of a watch according to the invention, with the bezel in the closed position and in the deployed position, respectively.

### DETAILED DESCRIPTION OF THE INVENTION

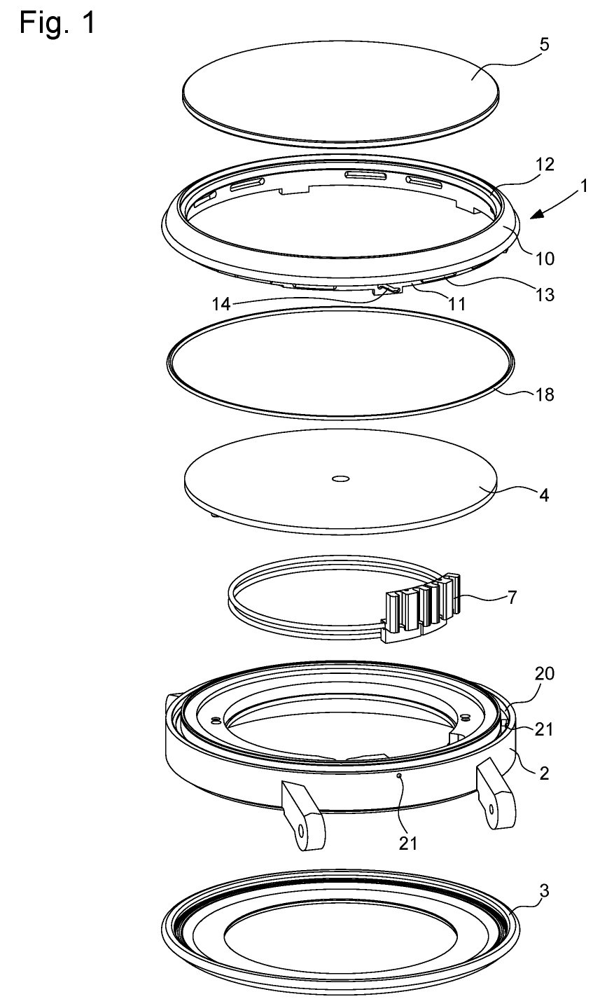

FIG. 1 illustrates a watch according to the invention comprising a watchcase consisting of at least a bezel 1, a middle 2, a back 3, a dial 4 and a glass 5. The watchcase also comprises a horology movement 6 paired with a striking mechanism 7.

The horology movement and striking mechanism are known per se and are represented schematically. The striking mechanism is designed to vibrate at least one gong or at least one blade, for example once or several times at regular intervals, every hour or when manually actuated, or even at a set time of day in the case of an alarm clock.

As can be seen in FIGS. 3a and 3b, the watchcase comprises an inner chamber 8 delimited by the dial 4 and the glass 5, the inner chamber 8 forming an acoustic cavity with an initial volume V.

The dial divides the watchcase into two superimposed spaces, which are an enclosed bed 8 holding the movement and striking mechanism, and the inner chamber 80 forming the acoustic cavity.

In the illustrated embodiment, the dial is an acoustic membrane, with the dial extending in a plane Pc.

According to the invention, the bezel 1 is telescopically fitted onto the middle and can move between a closed position and a deployed position to increase the initial volume V of the inner chamber.

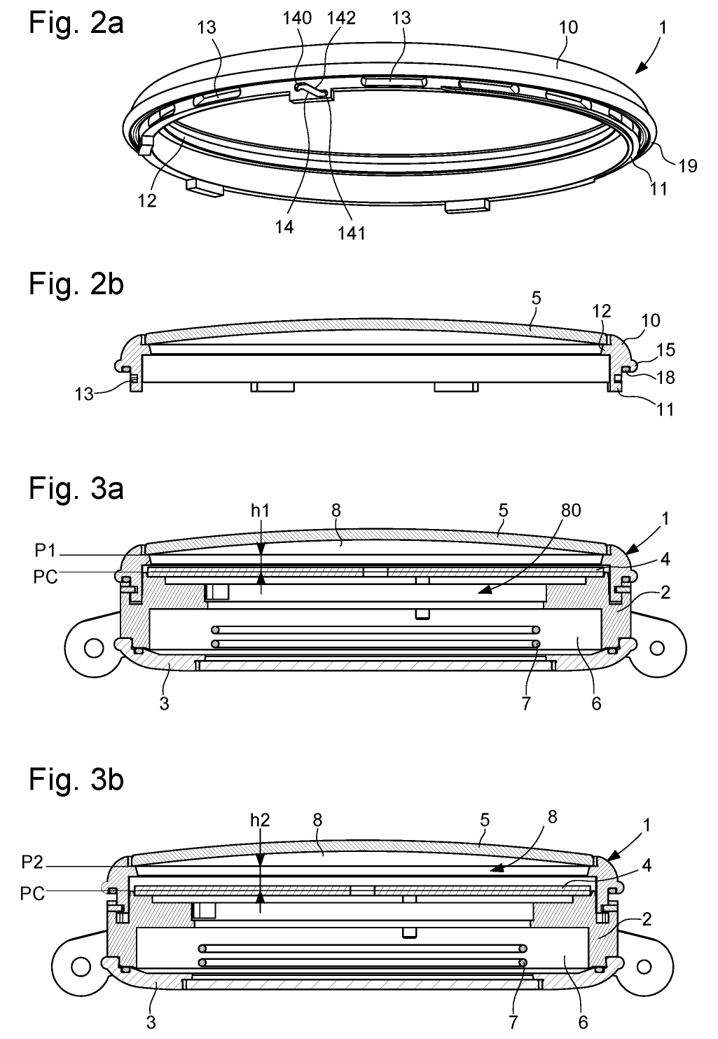

As can be seen in FIGS. 2a and 2b, the bezel 1 comprises an upper portion 10 designed to hold the glass 5 and a lower portion 11 connected to the middle 2, the lower portion 11 and upper portion 10 being delimited by a flange 12 on which the glass 5 bears, the glass being located in a first plane P1 parallel to the dial plane Pc. As illustrated in the figures, plane P1 is the plane formed by the upper rim of the raised edge on which the glass 5 is seated.

As can be seen in FIG. 1, the lower portion 11 of the bezel is designed to be seated in an annular groove 20 on the middle 2 and to engage with the middle 2 to move from the closed position to the deployed position.

The lower portion 11 comprises a shoulder arranged to bear against the middle 2 when the bezel is in the closed position. The shoulder also has a groove designed to hold a gasket 18 such that the watch is water-resistant when the bezel is closed, with the gasket 18 pressed against the middle 2. The gasket 18 can also be fitted in the middle 2.

The lower portion 11 also comprises at least one guide groove 14, and preferably at least two guide grooves 14 to limit the slack once the bezel 1 is assembled on the middle 2. The at least one guide groove 14 guides the bezel from the closed position to the deployed position, the guide groove 14 comprising two straight portions 140, 141 that are parallel to each other and connected by a ramp 142.

The straight portions 140, 141 of the groove 14, which are parallel to each other, form the closed and deployed positions of the bezel 1, and the ramp 142 enables the transition between the two positions.

The at least one groove 14 is arranged to engage with at least one pin 21 fitted so as to protrude into the annular groove 20, the pin being fixed and the groove being mobile relative to the pin/to the middle. As can be seen in FIG. 1, the at least one pin can be fitted from outside the middle 2 to make it easier to fit the bezel 1. It can also be provided that the at least one pin can be fitted from inside the middle.

According to an embodiment not illustrated in the figures, each planar portion 140, 141 has a bulge near its distal end so as to form a hard point when the pin 21 goes through the groove 14, thereby ensuring that the closed position or the deployed position of the bezel 1 is bolted.

Moving the bezel 1 from the closed position to the deployed position increases the distance between the dial 3 and the glass 5, as the bezel and glass move relative to the dial 3. As can be seen in FIGS. 3a and 3b, in the closed position, the dial plane Pc and the first glass plane P1 are spaced apart by a distance h1, and in the deployed position, the dial plane Pc and the second glass plane P2 are spaced apart by a distance h2, with distance h2 being greater than distance h1.

It is therefore understood that this arrangement of the bezel 1 on the middle 2 makes it possible to vary the initial volume V of the inner chamber 8. In this case, the volume of the internal chamber 8 is increased when the bezel 1 is in the deployed position.

As can be seen in the figures, the bezel 1 comprises at least one through orifice 13 through which the inner chamber 8 communicates with the outside of the watchcase so that the strike or music can be heard, the at least one orifice 13 being on the lower portion 11 of the bezel 1. The combination of the increased volume of the inner chamber 8 and the at least one orifice 13 thus amplifies and diffuses the sound of the strike or music outside the watch.

It should be noted that when the bezel is in the closed position, the lower portion 11 of the bezel is seated in the annular groove 20, thereby closing off the at least one orifice 13.

The lower portion 11 can comprise one or more orifices 13, the orifice or orifices 13 having a variety of possible shapes and orientations. As illustrated in the figures, the through orifices 13 are oblong in shape and are inclined towards the middle. Rectangular through orifices could also be considered, with the orifices extending in a plane parallel to the dial plane PC and to the glass plane P1.

Advantageously, the at least one through orifice 13 has a micro-perforated film to keep dust or dirt out of the watch. This micro-perforated film can be made of paper, textile, metal or even from a composite material, for example.

This watch design, particularly the bezel, is especially advantageous because the wearer can easily change the position of the bezel to improve the acoustic level on the dial side of the watch.

According to an alternative embodiment of the invention, the telescopic bezel is fitted to the back of the case in the same way as the bezel fitted to the front of the case.

Of course, the present invention is not limited to the illustrated example and is open to various variants and modifications as will be apparent to the person skilled in the art, without departing from the scope of the invention as defined by the claims.

1. A musical or striking watch (100) comprising a watchcase including a bezel (1), a middle (2), a back (3), a dial (4) and a glass (5), the glass (5) being attached to the bezel (1), the glass (5) and the dial (4) forming an inner chamber (8) with an initial volume (V), a movement (6) and a striking mechanism (7),
wherein the bezel (1) is telescopic and moves between a closed position in which the glass (5) is in a first plane (P1) parallel to the dial plane (Pc), to a second position in which the glass (5) is in a second plane (P2) distant from the first plane (P1) and parallel to the dial plane (Pc) so as to increase the initial volume (V) of the inner chamber (8).

2. The watch (100) according to claim 1, wherein the bezel (1) comprises an upper portion (10) designed to hold the glass (5) and a lower portion (11) connecting with the middle (2), the lower portion (11) and upper portion (10) being delimited by a flange (12) onto which the glass (5) is fastened.

3. The watch (100) according to claim 1, wherein the bezel (1) comprises at least one through orifice (13) through which the inner chamber (8) communicates with the outside of the watchcase so that the strike or music can be heard.

4. The watch (100) according to claim 3, wherein the at least one orifice (13) is on the lower portion (11) of the bezel.

5. The watch (100) according to claim 1, wherein the lower portion (11) of the bezel comprises at least one guide groove (14) for moving the bezel (1) from the closed position to the deployed position and inversely.

6. The watch (100) according to claim 1, wherein the middle (2) comprises an annular groove (20) for holding the lower portion (11) of the bezel and closing off the at least one orifice when the bezel (1) is in the closed position.

7. The watch (100) according to claim 1, wherein the annular groove (20) comprises protruding pins (21) arranged to engage with the at least one guide groove (14).

8. The watch (100) according to claim 1, wherein the bezel (1) comprises a gasket (18) suitable for engaging with the middle (2) when the bezel (1) is in the closed position.

9. The watch (100) according to claim 1, wherein the middle (2) comprises a gasket (18) suitable for engaging with the bezel (1) when the bezel (1) is in the closed position.

10. The watch according to claim 1, wherein the at least one through orifice (13) has a micro-perforated film to keep out dust or dirt.

11. The watch according to claim 9, wherein the micro-perforated film is made of paper, textile, metal or a composite material.

12. The watch according to claim 1, wherein the dial (4) forms an acoustic membrane.

13. The watch according to claim 1, wherein the telescopic bezel (1) is fitted to the back of the watch.
